(19) United States
(12) Patent Application Publication
(10) Pub. No.: US 2026/0049829 A1
(43) Pub. Date: Feb. 19, 2026

(54) SYSTEM

(71) Applicant: SOFTBANK GROUP CORP., Minato-ku, Tokyo (JP)

(72) Inventor: Hiroyasu HASHIMOTO, Minato-ku, Tokyo (JP)

(73) Assignee: SOFTBANK GROUP CORP., Minato-ku, Tokyo (JP)

(21) Appl. No.: 19/299,917

(22) Filed: Aug. 14, 2025

(30) Foreign Application Priority Data
Aug. 16, 2024 (JP) 2024-137331

(51) Int. Cl. G01C 21/36; G01C 21/34; G06V 10/94; G06V 20/50; G10L 15/22; G10L 15/30

(52) U.S. Cl. CPC G01C 21/3608; G01C 21/3415; G06V 10/95; G06V 20/50; G10L 15/22; G10L 15/30

(57) ABSTRACT

A system includes a processor that recognizes instructions provided by a user via voice input, captures images of the surrounding environment, analyzes acquired image data to identify obstacles and elevation changes, calculates an optimal route to a user's destination, controls movement based on the calculated route, transmits user instructions recognized by the voice recognition means as well as data analyzed by the image analysis means to a server and receives instructions from the server, and notifies the user of instructions received from the server by voice.

### CROSS-REFERENCE TO RELATED APPLICATION

This application is based on and claims priority under 35 USC 119 from Japanese Patent Application No. 2024-137331 filed on Aug. 16, 2024, which is incorporated by reference herein in its entirety.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional guidance systems for visually impaired individuals, such as guide dogs and traditional navigation devices, have several limitations. Guide dogs require extensive training and have limited capacity for dynamic hazard detection, while electronic navigation devices struggle to provide real-time, safe, and context-aware guidance. There is a need for a system that can automatically recognize user instructions, analyze the surrounding environment, identify obstacles, calculate and adjust navigation routes in real time, and communicate effectively with users to enable safe and independent outdoor mobility.

### SUMMARY

The present invention provides a system including a processor that recognizes user instructions supplied via voice input, captures images of the surrounding environment, analyzes such images to detect obstacles and elevation changes, calculates optimal routes to user-specified destinations, and controls movement based on the calculated routes. The system further includes means for communicating with a server to update navigation in real time, and notifying the user of instructions by voice. Additionally, the system receives user feedback and automatically updates its internal models to continuously improve performance and safety for visually impaired users.

“Voice input” means an audible instruction or command is provided by the user and received by the system for processing.

“Processor” means a hardware and/or software component executes control and processing functions of the system.

“Image data” means digital data representing photographs or video frames of the system's surrounding environment is captured by an imaging device.

“Obstacle” means any physical object or structure in the system's environment may hinder or block movement along the intended route.

“Elevation change” means a variation in surface height, such as a curb, step, or ramp, is present in the environment and requires detection for safe navigation.

“Route information” means digital data describing the path to be taken from the current location to the destination is determined by the system.

“Server” means a remote or external computer or computing device communicates with the system to assist in processing, analysis, or route calculation.

“User feedback” means information or input provided by the user about the system's performance or navigation experience is collected for analysis and learning.

“Real time” means actions, processing, and responses are performed with minimal delay, enabling immediate adaptation to changing environmental conditions.

“Notify” means the system informs or alerts the user by outputting information, particularly via synthesized speech.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

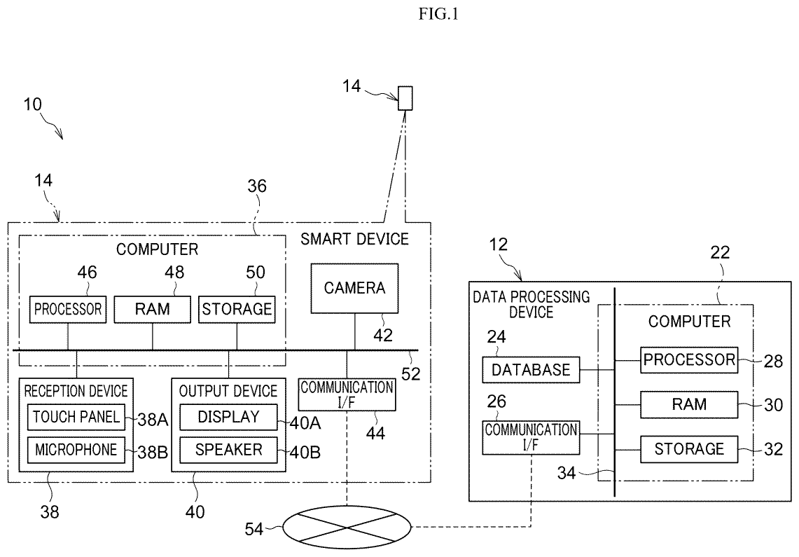

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

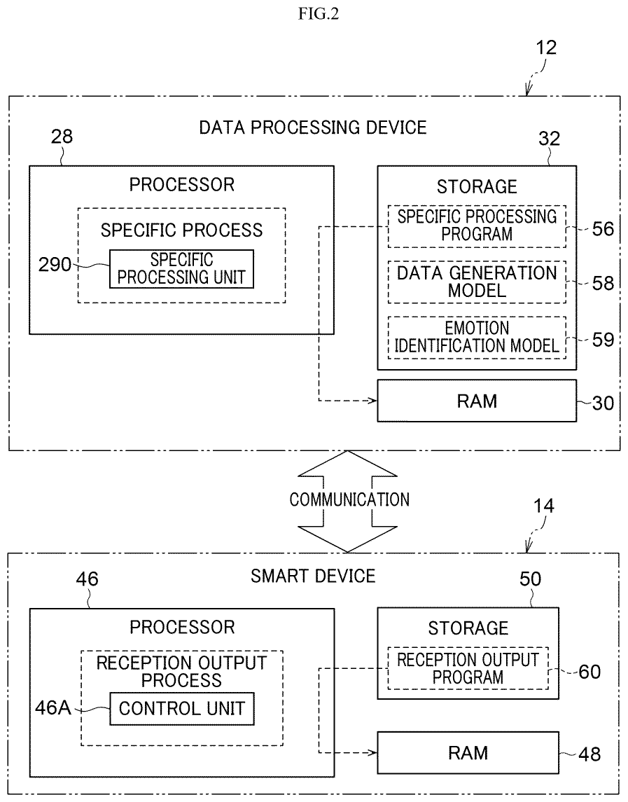

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Visually impaired individuals face significant challenges in navigating unfamiliar or dynamic environments safely and efficiently. Conventional mobility aids, such as guide dogs or simple assistive devices, lack the ability to dynamically perceive and interpret real-time environmental changes, detect and respond to sudden obstacles, or provide adaptive route guidance tailored to evolving surroundings. Additionally, previous solutions do not efficiently leverage user feedback to improve system performance over time. As a result, visually impaired users are often unable to travel independently and confidently in environments that include construction, temporarily blocked paths, or other unexpected hazards.

The specific processing by the specific processing unit 290 of the data processing device 12 in Example 1 is realized by the following means.

The present invention provides a server including a processor configured to receive and process acoustic input information from a user, acquire and analyze spatial information in real time to identify obstacles, dynamically compute optimal routes based on current environmental conditions and user destinations, control mobility mechanisms accordingly, communicate with an information processing apparatus for route and control updates, generate natural language guidance information, and present this guidance acoustically to the user, while also enabling model updates based on user feedback. This enables visually impaired individuals to navigate safely and efficiently in rapidly changing environments, ensures adaptive and responsive guidance, and allows continuous system improvement through interaction and feedback.

The term “processor” refers to an electronic circuit, device, or set of devices configured to execute instructions and perform data processing operations as specified by the system's programming, including arithmetic, logic, control, and input/output operations.

The term “acoustic input information” refers to data obtained from auditory signals, such as user speech or sounds, captured through a microphone or equivalent acoustic sensor.

The term “content information” refers to semantic or meaningful textual data that has been derived from processing acoustic input information, typically through speech recognition.

The term “spatial information” refers to data relating to the physical environment surrounding the system, including images, depth data, or any sensory data that represents surroundings for the purpose of environmental awareness.

The term “obstacle information” refers to data identifying the presence, position, and characteristics of objects or hazards in the environment that may interfere with or endanger the movement of the user or system.

The term “route information” refers to data representing a navigable path, including waypoints, directions, and instructions, calculated based on environmental data and the desired destination.

The term “mobility mechanisms” refers to actuated or mechanically controlled parts of a device or robot that enable movement, transportation, or physical navigation within an environment.

The term “information processing apparatus” refers to any electronic or computing device, including but not limited to centralized servers or distributed computing nodes, that receives, transmits, analyzes, or processes data within the system.

The term “control information” refers to data that provides operational instructions for guiding the actions or state of mobility mechanisms or other subsystems of the device.

The term “output information” refers to data that is presented to the user, particularly guidance or notification signals conveyed in acoustic form, such as spoken messages or alerts.

The term “guidance information” refers to instructional or advisory content, typically generated in a natural language, that directs or informs the user about navigation actions or environmental factors.

The term “generative information processing apparatus” refers to a computational system or subsystem that creates guidance content in natural language, possibly utilizing models such as generative artificial intelligence, based on current data and user context.

The term “response information” refers to data representing feedback, actions, or other input provided by the user in response to system instructions, which may be used for adaptive learning or system improvement.

The term “model” refers to a set of algorithms, parameters, or trained neural networks employed by the system to process information, generate guidance, or adapt to feedback during operation.

An embodiment for implementing the invention will be described below in detail, with reference to the technical scope of the claims.

The system includes a terminal device (such as a quadruped robot engineered for mobility assistance), a server (or information processing apparatus), and necessary sensing and communication hardware. The terminal is equipped with a microphone for receiving acoustic input, a 360-degree camera or multiple image sensors for capturing spatial information, speakers for providing acoustic output, and actuators (for example, electric motors and controllers) for mobility. The processor within the terminal may consist of embedded hardware platforms such as Raspberry Pi 4, NVIDIA Jetson, or similar devices capable of running edge AI workloads. The server component utilizes general purpose server hardware equipped with a graphics processing unit (GPU), capable of executing advanced machine learning algorithms and route calculations.

Software components include a speech recognition module, which may utilize a cloud-based speech-to-text service (for example, a generic cloud speech recognition API) to convert the user's spoken instructions into text-based content information. The spatial information analysis is accomplished by leveraging deep learning-based object detection algorithms, such as a general object detection neural network (e.g., based on YOLO technology), to identify obstacles and environmental hazards within the camera images. The server performs this image analysis and maintains a dynamic environmental map.

For route computation, the server applies a navigation algorithm such as Dijkstra's algorithm or the A* algorithm, implemented via a general-purpose computational framework (e.g., Python's NetworkX or a similar graph library). Route calculation incorporates real-time spatial information, previously detected static map data, and dynamic obstacles. The computed route information, along with specific motion directives and environmental warnings, is transmitted to the terminal over a secure network connection, for instance using HTTPS.

The terminal controls its mobility via onboard software (for instance, utilizing the Robot Operating System, ROS) which interprets the route instructions and controls the actuation hardware so that the robot navigates physically along the recommended path.

The terminal provides acoustic guidance to the user using a text-to-speech module, which may be based on a generic TTS engine (cloud-based or installed locally), converting system instructions and hazard notifications into spoken messages delivered through onboard speakers. Guidance content can be generated via a generative AI model, which creates clear, context-aware navigation instructions based on the calculated route and detected obstacles.

User feedback and responses may be acquired via onboard sensors (microphone or buttons) and are transmitted to the server, which employs a learning module to dynamically update system models—such as the guidance generation process—thus enhancing the system's adaptability and user experience.

For example, when a user wishes to travel to a nearby supermarket, the user verbally gives this command to the robot. The terminal captures the speech and sends the audio data to a cloud-based speech recognition module, converting the input into text. The terminal's camera captures its surroundings and sends image data to the server. The server analyzes the image to detect obstacles such as construction areas or temporarily blocked paths, calculates an appropriate route avoiding all hazards, and sends navigation instructions back to the terminal. The terminal guides the user step by step, adjusting the route in real time if new obstacles are detected.

A sample prompt sentence used for generating guidance with a generative AI model may be as follows:

“Given the following waypoints and real-time obstacle detections, generate step-by-step spoken instructions for a visually impaired person. For each significant change in route or environment hazard, give a clear, simple sentence. Example input: Route: forward 25 meters, turn left, cross at the next intersection. Real-time hazard: a bicycle is blocking the left path at 10 meters ahead. Please output: ‘Please walk straight for about 25 meters. There is a bicycle ahead on the left, so keep to the right. At the next intersection, please turn left and cross the street at the crosswalk.“ ”

Through such integration of multi-modal sensing, advanced AI-based data processing, dynamic route calculation, and adaptive user communication, the system enables visually impaired users to perform safe, autonomous, and context-aware navigation in complex or unpredictable environments.

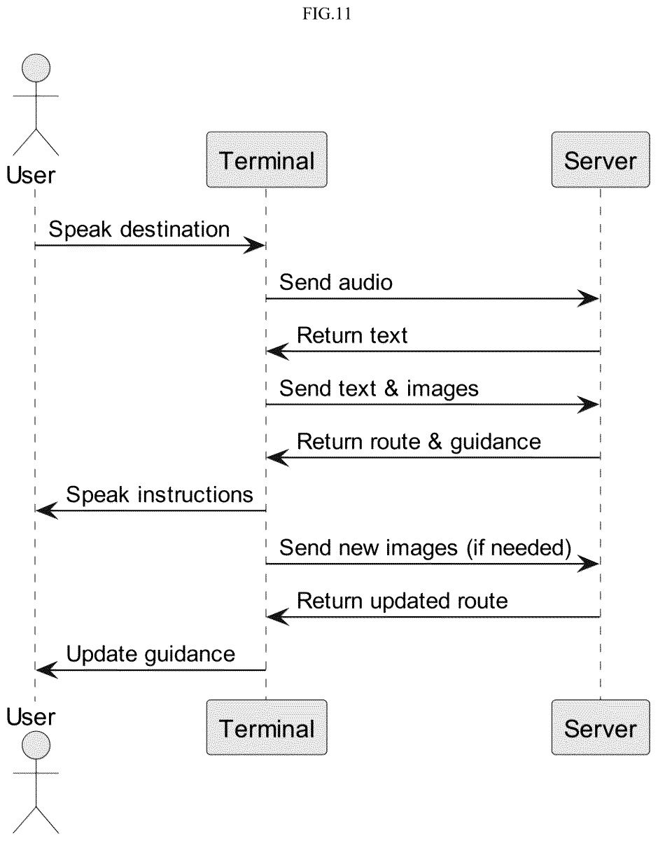

The following describes the processing flow using FIG. 11.

### Step 1:

User provides a voice command indicating the desired destination, such as “I want to go to the nearest pharmacy,” by speaking into the microphone attached to the terminal.

Input: User's spoken command.

The user clearly voices their navigation request while gripping the terminal's guidance handle.

Output: Audio data captured by the terminal's microphone.

### Step 2:

Terminal captures the audio input and transmits it to a cloud-based speech recognition service for conversion into text.

Input: Audio data from the user.

The terminal streams the recorded audio via a wireless module to the speech recognition server, processes the received response, and extracts the recognized text.

Output: Text data representing the user's intention (e.g., “I want to go to the nearest pharmacy”).

### Step 3:

Terminal packages the recognized text along with metadata (such as device ID and timestamp) and sends it to the server over a secure network channel.

Input: Text data, device metadata.

The terminal creates a structured JSON message and sends it through an HTTPS POST request to the server's endpoint.

Output: Data packet received by the server for route planning.

### Step 4:

Terminal activates the 360-degree camera to acquire high-resolution environmental images, which are then compressed and transmitted to the server for analysis.

Input: Physical surroundings.

The terminal captures panoramic image frames, encodes them in JPEG format, adds positional and temporal tags, and uploads the images to the server's image analysis interface.

Output: Image data packets uploaded to the server.

### Step 5:

Server receives the images and applies a deep learning-based object detection algorithm to recognize obstacles, changes, and potential hazards in the environment.

Input: Image data from the terminal.

The server decodes the images, runs them through a trained object detection neural network, and compiles a list of detected objects with classifications, coordinates, and confidence scores.

Output: Structured environmental data containing obstacle types and locations.

### Step 6:

Server uses the user's destination and current position, along with the analyzed environmental data, to compute an optimal walking route utilizing a pathfinding algorithm.

Input: Destination text, current device position, obstacle data.

The server runs a route calculation process, such as a Dijkstra or A* algorithm, on a digital map, prioritizing safe, efficient paths and avoiding detected hazards.

Output: Waypoints and turn-by-turn instructions represented as route data.

### Step 7:

Server composes guidance content in natural language, optionally using a generative AI model, and sends both route data and instructions to the terminal.

Input: Route waypoints, obstacle data.

The server forms a guidance message like, “Go straight 20 meters, turn right, avoid construction,” and packages the instructions for transmission.

Output: Route data and guidance text forwarded to the terminal.

### Step 8:

Terminal receives the route and guidance, and initiates autonomous locomotion by controlling its motors and actuators as specified by the received instructions.

Input: Route data, guidance instructions.

The terminal parses the waypoints, translates them into control signals for its actuators, and commences movement along the safe path.

Output: Control commands sent to mobility mechanisms; physical movement of the terminal.

### Step 9:

Terminal provides real-time spoken guidance to the user by converting the natural language instructions into speech via a text-to-speech engine and playing it through onboard speakers.

Input: Guidance text from the server.

The terminal uses a TTS module to synthesize the guidance (“Please keep to the right, cross the street after 10 meters”) and audibly presents it to the user.

Output: Spoken navigation instructions delivered to the user.

### Step 10:

Terminal continuously captures live environmental images and monitors for unexpected changes or new obstacles during navigation. If a new obstacle is detected, the terminal sends updated images to the server and requests a route recalculation.

Input: Live camera stream, environmental feedback.

The terminal identifies a new hazard, suspends movement, and transmits relevant data back to the server for immediate analysis and instruction update.

Output: Notification and updated image data sent to the server for dynamic re-routing.

### Step 11:

User follows the guidance and walks with the help of the terminal as it adapts and updates navigation in real time.

Input: Spoken commands and physical guidance.

The user responds to instructions, continues to provide vocal input or feedback if needed, and proceeds towards the destination.

Output: Safe and efficient user navigation to the selected destination.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional mobility assistance systems for visually impaired users often lack real-time adaptability to sudden environmental changes and fail to sufficiently address user anxiety or emotional states during navigation. These limitations can result in unsafe guidance, reduced efficiency, and increased psychological stress for users, particularly in dynamic or unpredictable urban environments. There is a need for a technology that not only navigates optimally but also dynamically senses and responds to both external hazards and the emotional well-being of the user, and that can continuously improve its performance using user feedback.

The specific processing by the specific processing unit 290 of the data processing device 12 in Application Example 1 is realized by the following means.

The present invention provides a server including a processor configured to recognize user instructions from audio input, estimate the user's emotional state from audio or facial expressions, capture and analyze environmental information to detect obstacles, calculate an emotionally adaptive guidance route, control movement of a mobile body based on both physical and emotional context, communicate dynamically with external processing apparatuses for instruction updates, output audio guidance tailored to the user's emotional needs, and update internal models and route algorithms based on received user feedback. This enables real-time, safe, and psychologically supportive mobility guidance for visually impaired users, with continuous learning and adaptability to changes in both the external environment and the user's emotional condition.

The term “processor” refers to a computational unit or combination of computational units capable of executing programmed instructions to perform data processing, analysis, and control operations within the system.

The term “user instruction” refers to a command or request provided by the user, typically in the form of spoken audio input, indicating a desired destination or operation for the system.

The term “audio input” refers to sound signals, such as the user's spoken commands, that are captured by a microphone or other audio recording device for further processing.

The term “emotional state” refers to a psychological or affective condition of the user, such as anxiety, calmness, or happiness, which is estimated based on analysis of the user's audio tone or facial expression.

The term “facial expression” refers to the visible movements or positions of a user's facial muscles, captured via an imaging device, which are analyzed to infer emotional cues.

The term “environmental information” refers to data representing the physical surroundings of the user and the mobile body, including obstacles, terrain, and landmarks, captured by imaging devices or sensors.

The term “imaging device” refers to any apparatus, such as a camera or optical sensor, used to capture visual data of the surrounding environment or the user.

The term “obstacle” refers to any physical object or terrain feature in the environment that may impede or affect the movement of the mobile body or pose a risk to the user.

The term “route information” refers to data specifying a navigational path from the user's current location to a destination, including step-by-step guidance instructions.

The term “guidance route” refers to a selected navigational path determined by the processor to optimize the safety, efficiency, and emotional comfort of the user during movement.

The term “candidate route” refers to any potential navigational path, among a plurality of alternatives, that may be evaluated by the processor for suitability before selection.

The term “mobile body” refers to a robotic or autonomous moving unit that physically guides the user along a route by executing corresponding movement commands.

The term “output unit” refers to any apparatus, such as a speaker or haptic feedback device, configured to present guidance, instructions, or other notifications to the user.

The term “information processing apparatus” refers to a computational system, which may be remote or external to the mobile body, responsible for advanced data analysis, storage, or communication handling within the system.

The term “external communication network” refers to any data transmission infrastructure, such as wireless or wired networks, used to enable communication between the mobile body, information processing apparatus, and other entities.

The term “feedback information” refers to evaluative data provided by the user regarding their experience, impressions, or assessments of the system's guidance and operation.

The term “emotional estimation model” refers to a computational framework or algorithm employed to infer the user's emotional state from data such as audio input or facial expression.

The term “route selection algorithm” refers to a set of computational procedures or rules used by the processor to evaluate candidate routes and select an optimal guidance route based on various factors, including environmental data and user emotion.

The term “audio message” refers to an auditory notification, instruction, or feedback that is generated and delivered to the user to aid in navigation or provide comfort.

The term “real time” refers to system operations and responses that occur sufficiently promptly in relation to user input or environmental changes such that they enable effective and safe adaptive guidance.

### Embodiment for Practicing the Invention

The present invention can be implemented as an intelligent mobility assistance system for users with visual impairment, where the system includes a processor, a mobile body, and external or integrated information processing apparatuses. The system integrates hardware components such as a microphone, an imaging device (for example, a 360-degree camera), a mobile actuator, a speaker (output unit), communication modules, and various sensors. The program executed by the processor utilizes software modules such as an automatic speech recognition engine, an emotional estimation model, an object detection and image analysis library (such as a general-purpose image processing library), a map service interface for route calculation, a text-to-speech module, and a data transmission framework for communication.

The user issues an instruction to the system using natural speech, such as “I want to go to the nearest supermarket.” The terminal device captures the user's speech through the microphone and obtains a facial image through the camera. The terminal executes processing with an automatic speech recognition library to convert the audio into text data and applies an emotional estimation model to determine the user's emotional state based on features such as voice tone and facial expression. Both the text instruction and emotional state are transmitted, using a wireless communication module (for example, a wireless LAN or cellular network device), to the information processing apparatus (server).

The terminal also acquires environmental information by using the 360-degree camera to capture images of the surroundings. These environmental images are analyzed on the server using image analysis software (for example, an object recognition library) to identify obstacles, terrain elements, or changes affecting navigation. The results of the image analysis, along with the user's input and emotional state, are provided to the route calculation module (such as a general map service API), which determines one or more candidate routes to the destination. The selected guidance route can be optimized for safety, efficiency, and for reducing user anxiety by considering emotional state as an evaluation parameter.

The server transmits step-by-step guidance information to the terminal, where the text is converted to voice using a text-to-speech engine and output to the user through the speaker. The mobile body is autonomously controlled along the guidance route using a movement control algorithm, which adjusts operation dynamically based on obstacle detection or changes in the user's emotional state.

Throughout guidance, the terminal continuously monitors the user's emotion and the environment, transmitting updates to the server. If real-time changes such as an unexpected obstacle or a shift in user emotion are detected, the server uses its computational modules—including the generative AI model—to recalculate the route and generate updated, supportive voice guidance messages as necessary. For instance, if the user appears anxious near a construction area, the server may select an alternate quiet street and instruct the terminal to communicate, “Don't worry, I will take you along a safe detour.”

After reaching the destination, the terminal solicits feedback from the user (for example, “Did you feel comfortable during your walk?”) and interprets the spoken or selected response using the speech recognition system. The server receives the feedback and updates both the emotional estimation model and route selection logic, using general-purpose machine learning frameworks, to improve future user experience.

Concrete examples of prompt sentences for the generative AI model during operation are as follows:
“Transcribe speech: ‘I want to go to the nearest supermarket.“ ”
“Estimate user emotion from this audio and facial image.”
“From this environmental image, identify potential obstacles for a visually impaired person.”
“Generate a supportive message for a user feeling anxious at a crosswalk.”
“Based on the user feedback: ‘I felt anxious crossing the street,’ suggest a method to increase reassurance.”

As such, the system of the present invention enables advanced safety and psychological support for visually impaired individuals by dynamically integrating multimodal data processing, emotional adaptation, route optimization, and user feedback learning into a unified, adaptive mobility guidance platform.

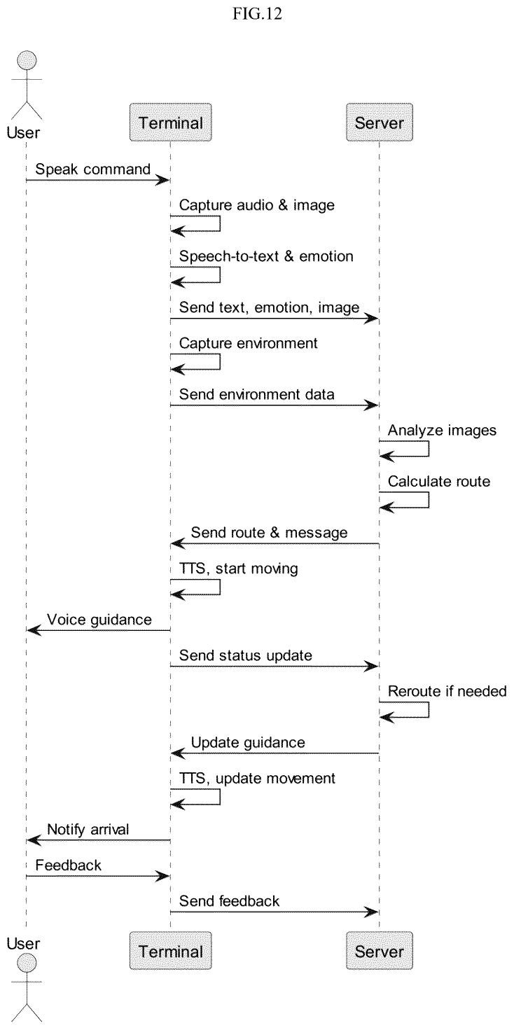

The following describes the processing flow using FIG. 12.

### Step 1:

User provides a verbal instruction, such as “I want to go to the nearest supermarket,” by speaking into the microphone attached to the terminal.

Input: User's spoken command.

Data processing: User's audio is captured as a digital sound file.

Output: Recorded audio data.

### Step 2:

Terminal receives the audio input and simultaneously captures an image of the user's face using the built-in camera.

Input: Audio data and facial image.

Data processing: Terminal preprocesses audio (noise reduction, segmentation) and formats the facial image.

Output: Preprocessed audio file and facial image data.

### Step 3:

Terminal processes the audio through a speech recognition module to convert the spoken command into text, and also analyzes the audio and facial image with an emotion estimation model to determine the user's emotional state.

Input: Preprocessed audio file and facial image data.

Data processing: Runs speech-to-text conversion and extracts emotional cues from both modalities using the emotion estimation model.

Output: Command text and estimated emotional state.

### Step 4:

Terminal sends the command text and emotional state to the server over a wireless network, and then uses a 360-degree camera to capture environmental images around the user.

Input: Command text, emotional state, and real-time environmental scene.

Data processing: Packaging data into a transmission-ready format; capturing and compressing environmental images.

Output: Data packet containing command text, emotional state, and a set of environmental images.

### Step 5:

Server receives the command text, the estimated emotional state, and the environmental images from the terminal. Server performs image analysis using an object detection library to identify obstacles, terrain features, and key landmarks.

Input: Command text, emotional state, and environmental images.

Data processing: Analyzing images using object detection/segmentation, linking results to a digital map.

Output: List of recognized obstacles and a contextual understanding of the current location.

### Step 6:

Server uses the command text, emotional state, and environmental analysis results as inputs for the route calculation module (map service API), and computes several candidate walking routes. If the user is anxious, the server prefers wider and quieter paths and includes emotional adaptation in the evaluation.

Input: User destination (text), emotional state, and obstacle data.

Data processing: Generates candidate routes, ranks them by safety and comfort, and selects the optimal route using a generative AI model to adapt supportive guidance as needed. Output: Step-by-step optimal route guidance and adapted audio script.

### Step 7:

Server sends the calculated route and adapted guidance messages to the terminal.

Input: Step-by-step route instructions and audio messages.

Data processing: Encodes instructions for efficient communication, packages the data, and transmits to the terminal.

Output: Route and script delivery package.

### Step 8:

Terminal receives the instructions and uses a text-to-speech (TTS) engine to generate audio output for the user. The terminal activates the movement control module on the mobile body, initiating movement following the provided guidance.

Input: Route guidance and audio scripts.

Data processing: Converts text instructions into synthesized speech, issues movement commands to actuators, and initiates real-time user guidance.

Output: Spoken audio instructions to the user and movement of the mobile body.

### Step 9:

Terminal continually monitors the user's facial expressions and tone of voice for emotional state changes with the emotion engine, and uses real-time environmental sensing to detect new obstacles or route changes. Any significant finding is flagged and sent to the server.

Input: Live facial video, real-time audio, and environmental sensor data.

Data processing: Extracts emotional features, identifies unexpected obstacles, and determines if route update is needed.

Output: Alert or update packet sent to the server.

### Step 10:

Server receives continuous updates on the user's condition and the environment. If a significant obstacle or emotional issue is detected, the server recalculates the route and invokes the generative AI model to adjust the audio guidance for emotional support, transmitting new instructions to the terminal.

Input: Emotional state alerts, obstacle data, and current route.

Data processing: Recomputes optimal route, generates adaptive guidance, and prepares new communication package.

Output: Updated route instructions and supportive audio messages.

### Step 11:

Terminal receives and implements new instructions, seamlessly continuing to guide the user with adaptive verbal support and safe route navigation.

Input: Updated route information and revised spoken guidance.

Data processing: Produces new audio output for the user, updates movement plans as needed, and assures transition to the revised route is smooth.

Output: Spoken adaptive guidance and continued movement on the new route.

### Step 12:

Terminal, upon arrival at the destination, announces the arrival to the user and requests feedback on the experience.

Input: Arrival event and user's verbal feedback.

Data processing: Converts audio feedback to text, optionally analyzes emotion in the response.

Output: Feedback text and user emotional state for transmission.

### Step 13:

Server receives the feedback from the terminal and uses it to update the emotional estimation model and the route selection logic, improving the system's responsiveness to both environment and user state in future guidance sessions.

Input: User feedback data and emotional cues.

Data processing: Stores feedback, retrains relevant AI models as appropriate, and refines guidance logic based on accumulated data.

Output: Updated models and improved system operation for future use.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional assistive navigation systems for visually impaired users face several limitations. These include the inability to recognize the user's emotional condition in real time, insufficient adaptability in route guidance when unexpected obstacles or environmental changes occur, and limited capacity to provide supportive feedback tailored to the user's psychological state. Furthermore, most existing systems lack the ability to enhance their performance dynamically based on continuous user feedback and biometric data, resulting in reduced safety, comfort, and autonomy for users during independent mobility.

The specific processing by the specific processing unit 290 of the data processing device 12 in Example 2 is realized by the following means.

The present invention provides a server including a processor configured to acquire audio and image information from a user and surrounding environment, analyze the acquired information by utilizing generative AI models to extract user intent and recognize obstacles, generate and adapt optimal route information based on the real-time situation and user objective, analyze biometric and emotional information to generate tailored feedback, perform control command processing for autonomous mobility assistance, and update the generative AI model and analysis models based on user feedback and biometric data. This enables real-time, adaptive route guidance and personalized feedback according to both environmental and individual emotional conditions, thereby enhancing user safety, comfort, and independence.

The term “audio information” refers to signals or data representing sounds, including spoken voice commands, captured from a user for processing and analysis by the system.

The term “intent information” refers to data extracted from user inputs, such as speech or gestures, which indicates the user's desired action or destination.

The term “environmental space information” refers to data representing the physical surroundings of the user, including images or other sensor data acquired by the system for situational awareness.

The term “image information acquisition device” refers to a device or component, such as a camera or sensor array, configured to capture visual or spatial data from the environment.

The term “obstacle factors” refers to physical objects, features, or conditions in the user's environment that may hinder or prevent movement, such as steps, barriers, or moving vehicles.

The term “route information” refers to data describing an optimal path or sequence of movements generated for a user to reach a specified destination safely.

The term “movement mechanism” refers to the set of hardware and software components responsible for physical locomotion of the device or robot, based on control inputs from the processor.

The term “information processing device” refers to a computational unit, server, or cloud-based service responsible for receiving and analyzing data, and generating control commands or feedback for the system.

The term “control command information” refers to instructions generated by processing units to manage the operation or behavior of system components, including navigation or user communication.

The term “audio information as a notification” refers to information that has been converted into audible speech or sound and is delivered to the user to convey instructions, feedback, or guidance.

The term “biometric information” refers to physiological or behavioral data collected from the user, such as heart rate, facial expressions, or voice tone, used to infer the user's state or condition.

The term “emotional state information” refers to data interpreted from user actions, expressions, or biometric signals that represent the psychological state, such as stress, anxiety, or calmness.

The term “feedback information” refers to signals, messages, or content provided to the user by the system, tailored to the user's current context, emotional state, or preferences.

The term “generative AI model” refers to an artificial intelligence algorithm capable of generating content or performing adaptive analysis, recognition, or inference based on input data, such as text, audio, or images.

The term “prompt sentence” refers to a formatted query or instruction provided as input to a generative AI model to elicit a specific output, response, or action.

The term “analysis models” refers to computational algorithms or machine learning models employed to interpret, classify, or evaluate data acquired by the system.

The term “response information” refers to feedback or data provided by the user in response to system output, used for system learning or adaptation.

The term “real-time regeneration” refers to the dynamic recalculation or updating of route or command information by the processor in response to changing environmental or contextual variables.

A preferred embodiment of the present invention is described below, supporting the technical scope set forth in the claims. The system includes a server provided with a processor and one or more terminals, such as a guide robot or mobile device, both network-connected. Typically, the server is implemented using a general-purpose computer or cloud computing environment equipped with a graphics processing unit (GPU) and various machine learning frameworks, whereas the terminal is implemented with a microcontroller or embedded processor, MEMS microphone, speaker, 360-degree camera, biometric sensors, and wireless communication modules such as Wi-Fi or 5G.

The terminal is equipped with hardware and software capable of acquiring environmental space information and user audio inputs. The terminal utilizes a built-in MEMS microphone to capture user speech, which is then processed using a generative AI model-based speech recognition engine, such as an open-source speech-to-text model or a commercially available solution. For real-time emotion analysis, the terminal applies a camera and facial recognition software—utilizing a generative AI model trained for emotion detection from facial features, operating either on the terminal or by uploading imagery to the server for processing.

In addition, the terminal acquires images of the environment using a 360-degree camera or other imaging sensors. Image data is either locally preprocessed or transmitted directly to the server for advanced analysis. The server performs environmental analysis using a generative AI model for object detection, such as a convolutional neural network, and identifies obstacle factors, traffic signals, or hazardous elements in the vicinity.

The server further integrates data from additional sources, such as weather APIs or municipal open data on construction, and generates optimal route information by applying a generative AI model-based path-planning algorithm that accounts for the user's intended destination, environmental factors, and the detected user emotional state. The server transmits the optimal route information and adaptive feedback instructions-such as playing relaxing music or encouraging speech-to the terminal through a secure wireless connection.

The terminal actuates the movement mechanism of the guide robot based on the server's control command information. The movement mechanism includes a motor controller, actuators, and sensor fusion software (for example, implemented using a robotic middleware platform). The terminal executes commands, provides audio notifications and feedback to the user using a text-to-speech module, and plays audio content as required.

Feedback and biometric data, such as detected user anxiety or calmness, is periodically transmitted from the terminal to the server, allowing the generative AI model and other analysis models to be incrementally updated through learning mechanisms. The learning module incorporates user response information to improve recognition accuracy and adapt system behavior over time.

For operation, the user simply interacts with the guide terminal by speaking their command and naturally moving with the device. The system autonomously manages environmental monitoring, navigation, and supportive feedback.

A specific example is as follows:

The user speaks into the terminal, “I want to go to the nearest supermarket.” The terminal recognizes this command using a generative AI speech model and captures the user's facial expression to detect their emotional state. The terminal's 360-degree camera collects images of the surrounding area. The server analyzes these images using generative AI-based object detection and acquires additional context such as weather and construction information. The server processes a prompt sentence such as:

“User is anxious and requests supermarket route. Detected: crosswalks, rain, construction. Please generate safest path and calming feedback.”

Upon receiving the server's response, the terminal initiates movement according to the generated route, gives step-by-step spoken instructions, and provides adaptive feedback, such as playing relaxing music or saying, “You're doing great.”

Through such hardware and software integration, the invention enables real-time, adaptive, and personalized navigation and support for visually impaired users. The environment, emotional status, and user feedback are all dynamically incorporated into the system operation, enabling safe, comfortable, and independent movement.

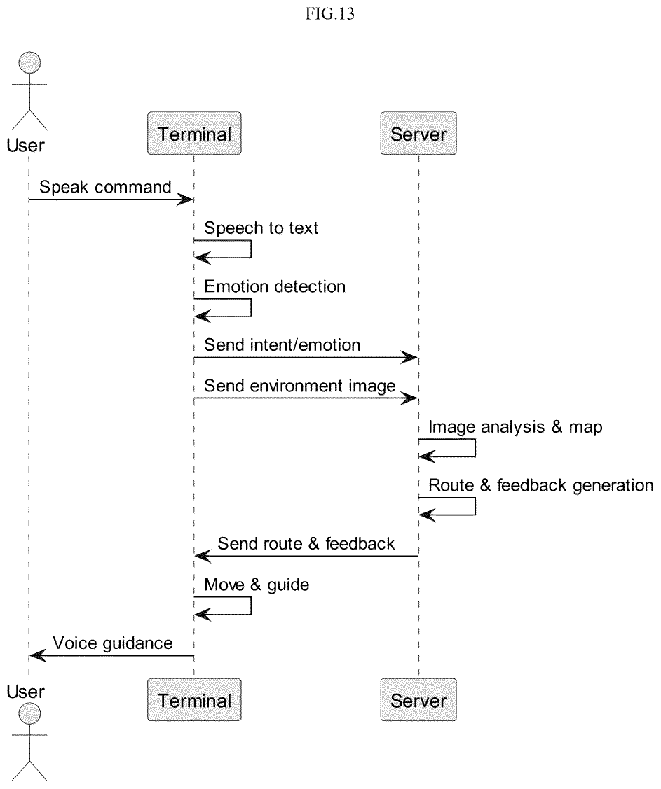

The following describes the processing flow using FIG. 13.

### Step 1:

User provides a voice command through the terminal's microphone.

Input: Spoken instruction from the user (e.g., “I want to go to the nearest supermarket”).

Output: Analog audio signal captured by the terminal.

The user clearly articulates their intention, ensuring the microphone records their voice.

### Step 2:

Terminal digitizes and processes the captured audio using a generative AI model for speech recognition.

Input: Analog audio signal.

Output: Recognized text representing the user's instruction.

The terminal converts the analog signal into digital data, applies the generative AI speech model, and extracts the intent from the spoken command.

### Step 3:

Terminal uses its camera to capture the user's facial expression or collects biometric data to detect the emotional state.

Input: Real-time image or biometric signal (such as heart rate).

Output: Emotional state label (e.g., “anxious”, “calm”, or “confident”).

The terminal processes the image or biometric input using a generative AI model for emotion recognition and assigns an appropriate label.

### Step 4:

Terminal composes a data package that includes the recognized text and emotional state, then transmits it to the server via a secure wireless protocol.

Input: Recognized text and emotional state label.

Output: Encoded data packet sent to the server.

The terminal bundles the relevant information, establishes a secure connection (e.g., 5G or Wi-Fi), and sends the data to the server.

### Step 5:

Terminal acquires environmental information using a 360-degree camera and transmits the images to the server.

Input: Real-time panoramic images of the environment.

Output: Encoded image data transmitted to the server.

The terminal captures current surroundings, compresses the image data, and sends it for analysis.

### Step 6:

Server processes incoming images with a generative AI model for object detection and environmental mapping.

Input: Environmental image data.

Output: Environmental map with identified obstacle factors and navigation-relevant features.

Server uses a generative AI model to recognize objects such as crosswalks, barriers, and steps, and constructs an environmental map.

### Step 7:

Server integrates user intent, emotional state, environmental map, and external data sources such as weather and construction updates.

Input: User intent, emotional state label, environmental map, and external context data.

Output: Aggregated dataset for route planning.

Server combines all received and retrieved contextual information into one dataset for subsequent processing.

### Step 8:

Server generates optimal route and adaptive feedback using a generative AI model and a prompt sentence tailored to the context.

Input: Aggregated dataset including all user and environmental information.

Output: Route instructions and adaptive feedback recommendations.

Server creates a tailored prompt sentence (e.g., “User is anxious and requests supermarket route. Detected: crosswalks, rain, construction. Please generate safest path and calming feedback.”), uses a generative AI model to process this prompt, and outputs step-by-step navigation and support strategies.

### Step 9:

Server transmits the optimal route and feedback information back to the terminal.

Input: Route instructions and adaptive feedback recommendations.

Output: Encoded control and feedback data received by the terminal.

Server packages the output into a data packet and sends it to the terminal over the secure communication channel.

### Step 10:

Terminal controls its movement mechanism according to the received route information, and initiates navigation.

Input: Route instructions.

Output: Movement commands executed by motors and actuators.

The terminal parses the route instructions and uses its motor controller and embedded software to navigate the physical environment.

### Step 11:

Terminal delivers real-time guidance and adaptive feedback to the user through its audio output system.

Input: Feedback instructions, emotional support messages, and navigation steps.

Output: Spoken instructions, encouraging messages, and possibly music or audio cues.

The terminal uses a text-to-speech engine to communicate the information and plays any recommended audio content for user reassurance.

### Step 12:

Terminal and server continuously monitor and update, exchanging new environmental and emotional information as the situation evolves.

Input: Updated environmental images, biometric data, and user responses.

Output: Dynamic system updates (route changes, feedback adjustments).

Terminal and server operate in a feedback loop, allowing for real-time adaptation and learning throughout the user's journey.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

There is a problem that visually impaired users lack effective technological means to receive comprehensive and adaptive support for safe, stress-reduced navigation and object finding in physical spaces, such as stores or public environments. In particular, conventional systems do not provide real-time recognition and adaptive feedback based on both environmental and emotional states of the user, nor do they generate personalized guidance using natural language processing and prompt sentence generation techniques according to the user's changing situation and emotion.

The specific processing by the specific processing unit 290 of the data processing device 12 in Application Example 2 is realized by the following means.

The present invention provides a server including a processor configured to recognize user instructions from acoustic information, acquire and analyze environmental information to identify hazards, calculate optimal routes, provide real-time emotion recognition, and generate and output adaptive guidance and emotional feedback based on both environmental and emotional states using natural language processing and prompt sentence generation. This enables visually impaired users to receive continuously optimized, personalized, and emotionally adaptive support for navigation and object search, thereby reducing anxiety and improving overall safety and independence.

The term “acoustic information” refers to data acquired from sound or speech signals, typically captured via a microphone, and used for recognizing user instructions or emotional states.

The term “user instruction” refers to a command or request provided by the user, generally in spoken or textual form, which is recognized and interpreted by the system.

The term “imaging device” refers to a hardware component such as a camera or sensor that captures visual information from the surrounding environment.

The term “environmental situation information” refers to collected data representing the physical surroundings of the user, including obstacles, elevations, and layout details.

The term “image information” refers to digital data derived from visual input captured by the imaging device, which may be processed for analysis.

The term “obstacle” refers to any physical object or feature in the environment that may impede or influence the movement of the user or mobile device.

The term “difference in elevation” refers to changes in height or surface level, such as steps, slopes, or curbs, which may affect the user's safe mobility.

The term “route” refers to a calculated sequence of directions or paths leading from the user's current location to a specified destination.

The term “mobile body” refers to any mechanism or system capable of movement, which is controlled in accordance with the calculated route, and may include robotic platforms or assistive devices.

The term “information processing device” refers to a computational unit, such as a server or processor, capable of receiving, analyzing, and transmitting data within the system.

The term “acoustic output” refers to audio signals, such as synthesized speech or sound, generated by the system to convey information or instructions to the user.

The term “emotional state” refers to the psychological condition or mood of the user as interpreted from voice or visual cues.

The term “adaptive information” refers to output that is dynamically generated by the system in response to detected environmental conditions or user states, particularly emotional cues.

The term “natural language processing” refers to a suite of computational techniques that allow the system to analyze, interpret, and generate human language in a meaningful way.

The term “guidance information” refers to directions, prompts, or instructions generated by the system to assist the user in navigating or finding objects.

The term “emotional support information” refers to content aimed at providing encouragement, reassurance, or positive feedback to the user according to their detected emotional state.

The term “prompt sentence” refers to a request or instruction, generated by the system or user, that specifies the content or manner of the guidance or emotional support to be produced.

The term “response information” refers to feedback provided by the user that may be used to refine or update the system's algorithms or models.

The term “model” refers to a collection of data, algorithms, or learned parameters in the system that can be updated or adapted based on new information or user responses.

An embodiment for implementing the invention is described as follows.

The system includes a processor that can be realized using commercially available computational hardware, such as a general-purpose personal computer, a cloud server, or an embedded computing device. The system includes an interface for input devices (such as a microphone and a camera), and output devices (such as a speaker or a tactile interface). The processor operates under software control, and the software may be implemented using standard programming languages and development environments.

The terminal is equipped with a microphone and a camera. The microphone is used to receive spoken instructions or free-form speech from the user. The camera, which may be a 360-degree or wide-angle camera, is used to acquire image data representing the user's surroundings. The terminal can be a mobile device, such as a smartphone, a wearable device, or a dedicated handheld device.

The processor running on the terminal or on a server uses a speech recognition engine, for example based on the SpeechRecognition library, to convert the received acoustic signal into text data and obtain the user instruction.

The camera provides image data of the environment, which is processed by the processor, either locally or on a server, using an image analysis library such as OpenCV. Through image analysis, the processor detects obstacles, differences in elevation (such as steps and slopes), and identifies features and locations within the environment.

The processor further analyzes the user's voice and, where applicable, facial expressions from the image data for emotional state estimation using an emotion recognition algorithm. Such an algorithm may be implemented with open-source software or custom code, and typically involves analysis of audio features (such as pitch, speed, and modulation) and facial features.

The processor is further configured to process the recognized user instruction and environmental situation using natural language processing tools. For example, the processor may employ software tools capable of prompt sentence generation, such as a generative AI model, or a rules-based expert system. This enables the system to formulate instructions, guidance, and supporting feedback appropriate to the user's current needs and emotional state.

A navigation algorithm, such as A* search or a proprietary navigation engine, is used by the processor to calculate an optimal route from the user's present location to a specified destination, using the obstacle and map information derived from the image analysis.

The processor controls the output devices (for example, text-to-speech synthesis using the gTTS library, or vibration actuators for tactile feedback) to inform the user of navigational instructions and emotional support. The instructions may include, for example, “Go straight and turn right,” as well as emotional reassurance such as “You are doing great. Please continue.”

Bidirectional communication between the terminal and the server can be accomplished using standard network protocols such as HTTP, HTTPS, or secure sockets. The system can operate in a cloud environment or on distributed computing hardware if required for scalability or redundancy.

The processor is also configured to receive user feedback, and to update the underlying model used for prompt generation and navigation as necessary. This may be implemented using machine learning or adaptive algorithm techniques.

A concrete example of system use is as follows. The user enters a store and, via the terminal's microphone, says, “Where are the tomatoes on the shelf?” The system recognizes this as a command, analyzes the captured environmental images to locate the position of the tomato shelf, assesses the presence of obstacles, and determines an appropriate route. If the user appears to be anxious, based on voice or image analysis, the system generates supportive feedback like “Do not worry, you are on the right path.” The output is synthesized to speech and communicated via the speaker. When the user approaches the target shelf, the system informs the user, “You have arrived. The tomatoes are on the right-hand shelf.”

An example prompt sentence for a generative AI model in this context may be:

“Based on the user's query and the real-time analysis of their emotional state, generate step-by-step audible navigation to guide a visually impaired person to the tomato shelf in a supermarket, and add phrases to provide encouragement if the user appears anxious.”

The described system is flexible and can be adapted for use in various real-world environments to support safe, independent navigation and task accomplishment, particularly for visually impaired individuals.

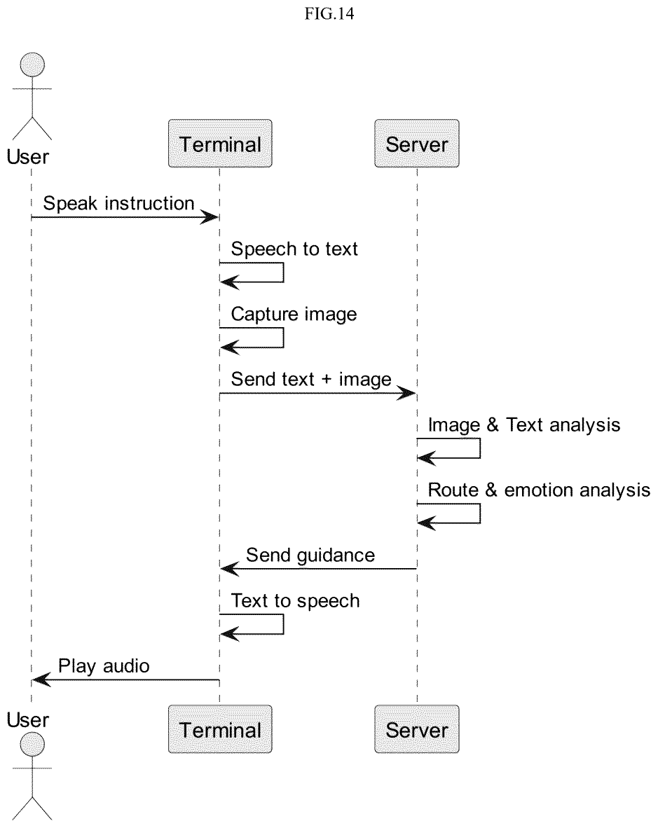

The following describes the processing flow using FIG. 14.

### Step 1:

User provides a spoken instruction to the terminal, such as “Where are the tomatoes on the shelf?”

Input: User's voice captured by the terminal's microphone.

Action: User articulates a natural-language command.

Output: Audio signal representing the spoken instruction.

### Step 2:

Terminal converts the audio signal to text using a speech recognition library.

Input: Audio signal of the user's instruction.

Action: Terminal processes the audio with a speech recognition engine (such as SpeechRecognition) and performs noise filtering if necessary.

Output: Text data containing the user's instruction (e.g., “Where are the tomatoes on the shelf?”).

### Step 3:

Terminal captures real-time environmental image data using the onboard camera.

Input: User location and current environmental conditions.

Action: Terminal operates the camera to capture images or video of the current surroundings, and adjusts camera settings based on lighting conditions if needed.

Output: Digital image data reflecting the current environment.

### Step 4:

Terminal transmits the recognized text and image data to the server over a network connection.

Input: Text data of the instruction and digital image data.

Action: Terminal generates a data packet, connects to the network (e.g., via Wi-Fi), and sends the information to the server using a secure protocol such as HTTPS.

Output: Data package received by the server.

### Step 5:

Server analyzes the received image data to detect obstacles and important features using an image recognition library.

Input: Digital image data from the terminal.

Action: Server applies image analysis through software (such as OpenCV) to identify objects, obstacles, difference in elevation, and relevant shelf locations.

Output: Structured data listing obstacles, points of interest, and shelf positions in the environment.

### Step 6:

Server processes the received text to extract the target object or destination using a natural language processing system.

Input: Text data containing the user's instruction.

Action: Server uses NLP techniques and a generative AI model to extract keywords (e.g., “tomato shelf”) and understand user intent.

Output: Target destination or object, and the user's intent.

### Step 7:

Server calculates the optimal route through the environment based on the analyzed surroundings and the user's intent.

Input: Structured map data from image analysis and user's requested destination.

Action: Server runs a pathfinding algorithm (such as A*) to generate a sequence of waypoints and a step-by-step route.

Output: Navigation instructions and route data.

### Step 8:

Server analyzes the user's emotional state from their voice data or, if available, from image data (face expressions).

Input: Audio features (such as pitch/tone) and/or facial images.

Action: Server applies an emotion recognition algorithm to assess whether the user is anxious, calm, or needs encouragement.

Output: Detected emotional state.

### Step 9:

Server generates an adaptive guidance and emotional support message using a generative AI model, incorporating prompt sentences if necessary.

Input: Navigation instructions, user's emotional state, and environmental data.

Action: Server creates detailed, step-by-step instructions and, if required, reassuring or encouraging phrases, possibly by sending a prompt sentence to a generative AI model (e.g., “If the user is anxious, add supportive language.”).

Output: Guidance message and emotional support text.

### Step 10:

Server transmits the guidance and support message to the terminal.

Input: Text including navigation and emotional feedback.

Action: Server sends the response via a secure communication protocol.

Output: Message received by the terminal.

### Step 11:

Terminal synthesizes the textual message into audio using a text-to-speech system, and outputs it via the speaker.

Input: Text message with navigational instructions and support.

Action: Terminal processes the text using gTTS or a similar TTS engine, creating an audio file that is immediately played to the user.

Output: Audible instruction and support provided to the user.

### Step 12:

User receives the guidance and proceeds along the indicated route, optionally responding if further assistance is needed or giving feedback that may be processed by the system for model updates.

Input: Audible navigation and support from the terminal.

Action: User follows the guidance physically and interacts with the terminal as necessary (e.g., asking new questions or saying “Thank you” upon arrival).

Output: Updated user location, system logs, and potential feedback data for system learning.

The data generation model 58 is a so-called generative artificial intelligence (AI). Examples of the data generation model 58 include generative Als such as ChatGPT (registered trademark)(Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

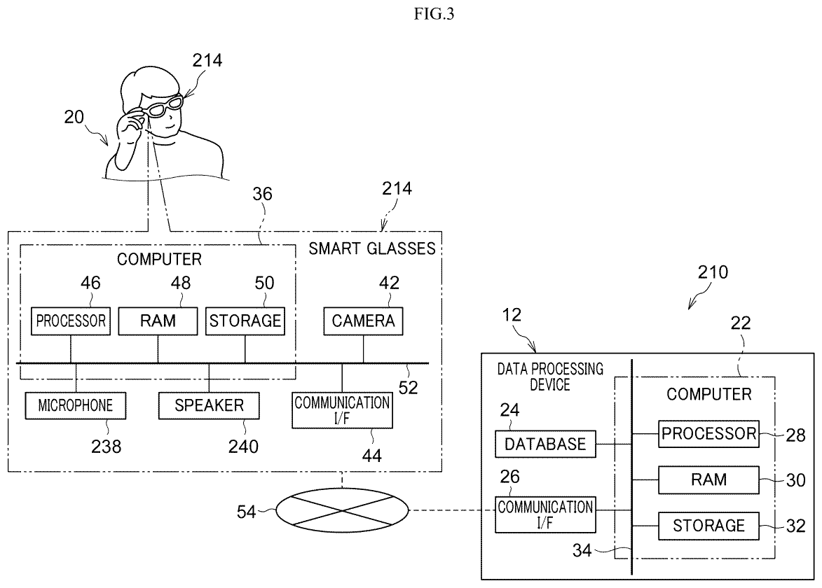

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

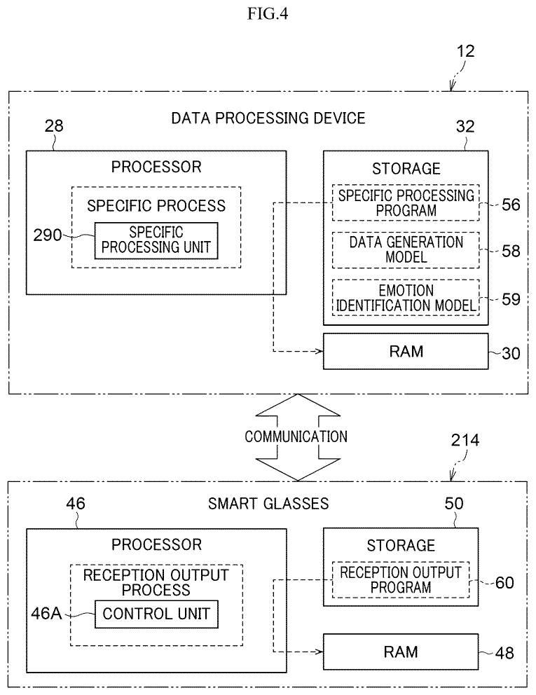

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark)(Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

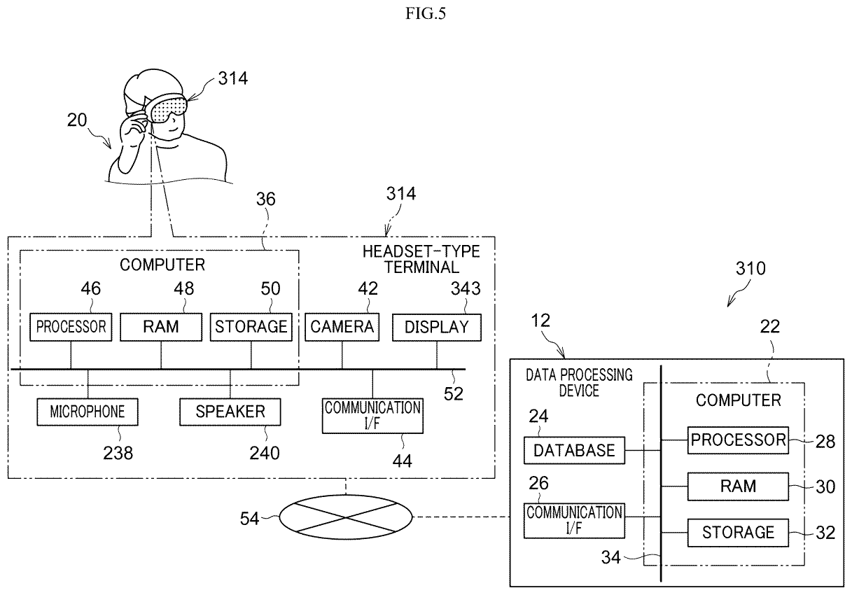

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

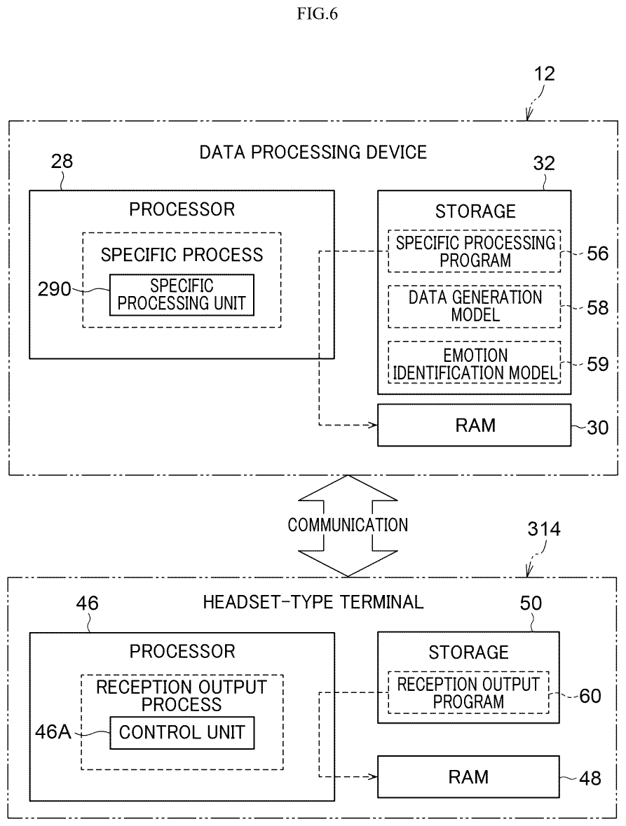

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark)(Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

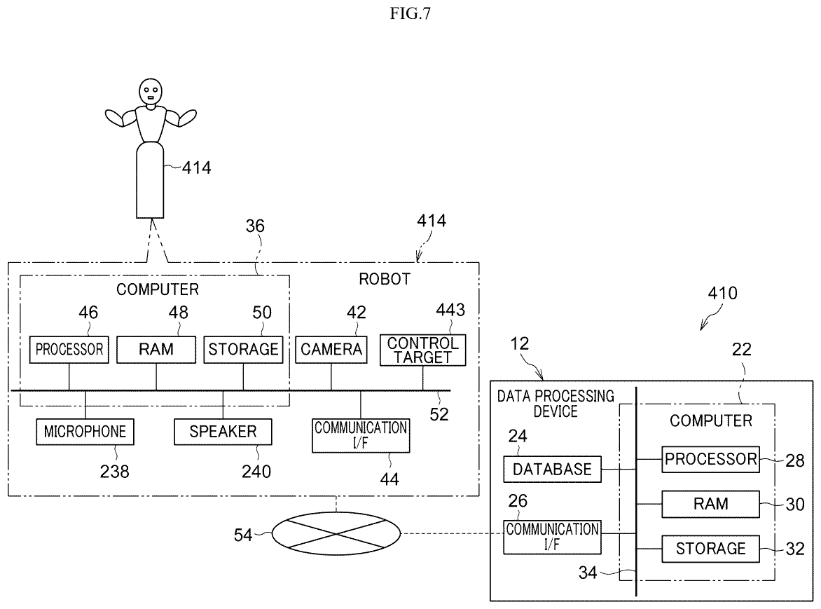

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

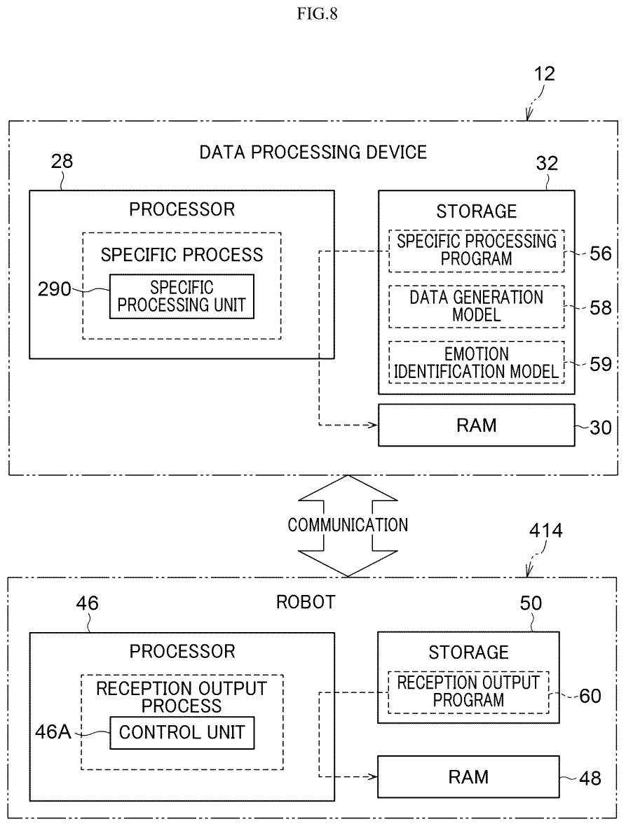

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark)(Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

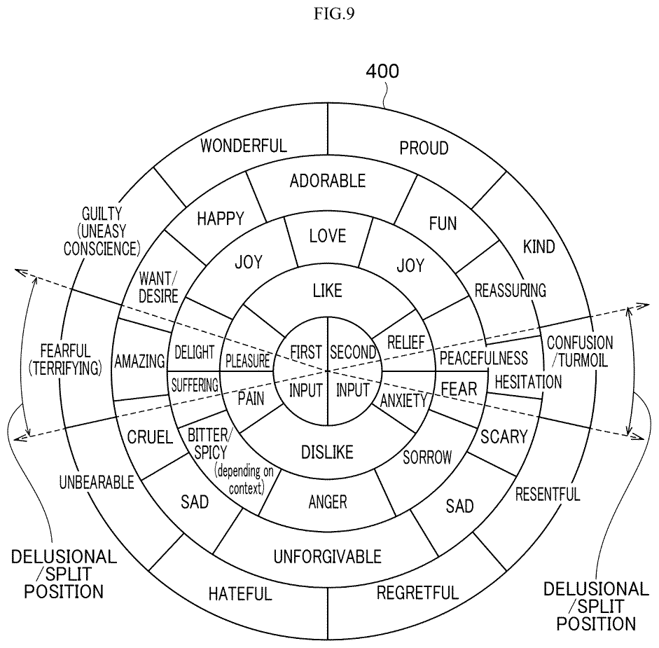

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

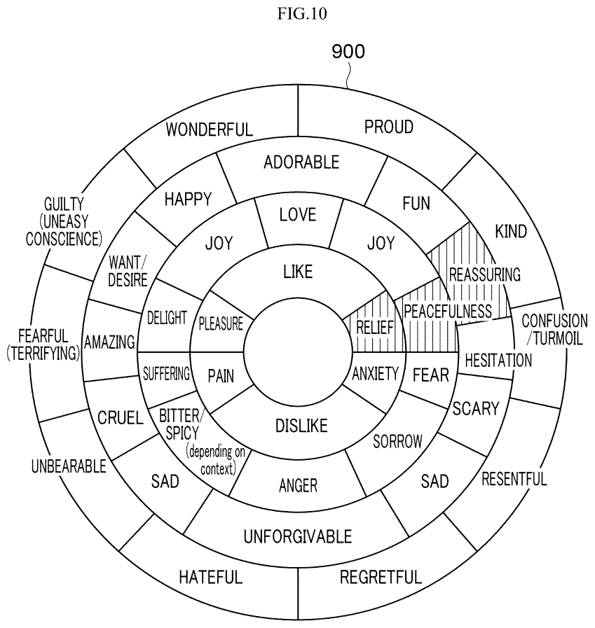

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system including a processor,
wherein the processor is configured to
process acoustic input information and convert it into content information,
acquire spatial information of the surroundings,
analyze the acquired spatial information to extract obstacle information,
dynamically compute route information based on a departure location and a destination,
integrate and control mobility mechanisms in accordance with the route information,
transmit information processed or computed by the acoustic input processing and spatial information analysis to an information processing apparatus, and receive control information from the information processing apparatus,
provide output information acoustically to a user based on the received control information,
recompute the route information dynamically in real time based on changes in the spatial information and coordinate with the integrated mobility control,
and generate guidance information in natural language by a generative information processing apparatus and present said guidance to the user through the output information provider.

### (Supplementary 2)

The system according to supplementary 1,
wherein the processor is configured to
analyze response information collected from the user, and dynamically update the model for at least the generation of guidance information.

### (Supplementary 3)

The system according to supplementary 1,
wherein the processor is configured to
transmit spatial and route information to the information processing apparatus, and, when necessary, dynamically recompute and receive new route information in real time as control information.

### Application Example 1

### (Supplementary 1)

A system including a processor,
wherein the processor is configured to
recognize an instruction input by a user via audio and convert the instruction into text data, estimate an emotional state of the user based on at least one of audio or facial expression,
capture environmental information of surroundings using an imaging device,
analyze the obtained environmental information to identify obstacles or terrain elements,
calculate route information to a destination of the user based on the destination information, the analyzed environmental information, and the estimated emotional state, and determine an appropriate guidance route from multiple candidate routes,
control movement of a mobile body along the guidance route and adjust its operation according to obstacles and the emotional state of the user,
transmit the estimated emotional state, environmental analysis result, and other information to an information processing apparatus, and perform communication using an external communication network to receive instructions,
output, via an output unit, guidance information or audio messages adapted to the emotional state received from the information processing apparatus to notify the user,
and monitor the guidance route, obstacles, and emotional state, and, when a change in the environment or in the emotional state is detected, dynamically recalculate or regenerate the route information and message content in cooperation with the external information processing apparatus.

### (Supplementary 2)

The system according to supplementary 1,
wherein the processor is configured to
receive user feedback information, such as impressions or evaluations, and update at least one of an emotional estimation model or a route selection algorithm based on the received feedback information.

### (Supplementary 3)

The system according to supplementary 1,
wherein the processor is configured to
transmit environmental information and route information acquired during guidance to the information processing apparatus, and, when an obstacle, environmental change, or change in user emotional state occurs along the route, cooperate with the external information processing apparatus to recalculate or regenerate the route information and audio message content in real time, and to output corresponding instructions based thereon.

### Example 2

### (Supplementary 1)

A system including a processor,
wherein the processor is configured to
acquire audio information as input information and extract intent information based on the audio information,
acquire environmental space information using an image information acquisition device,
analyze the acquired image information and identify obstacle factors,
generate optimal route information based on the user's movement objective information and the analysis results of the space information,
control the operation of a movement mechanism in accordance with the route information,
transmit information obtained by the audio information recognition and the image information analysis to an information processing device and receive control command information from the information processing device,
convert the received control command information to audio information and output the audio information as a notification,
analyze biometric information and emotional state information of the user and generate feedback information according to the analysis result,
perform various recognition, analysis, or inference processing by using a generative AI model and generate or process a prompt sentence.

### (Supplementary 2)

The system according to supplementary 1,
wherein the processor is configured to
update the generative AI model and various analysis models based on response information and biometric information provided from the user.

### (Supplementary 3)

The system according to supplementary 1,
wherein the processor is configured to
transmit acquired space information and route information to the information processing device and perform real-time regeneration of the route information and reception of control command information in accordance with a change in situation.

### Application Example 2

### (Supplementary 1)

A system including a processor,
wherein the processor is configured to
receive acoustic information to recognize a user instruction,
acquire environmental situation information using an imaging device,
analyze the acquired image information to identify obstacles and differences in elevation,
calculate a route to a user-specified destination,
control a mobile body based on the calculated route information,
transmit the recognized user instruction and analyzed information to an information processing device and receive instructions therefrom,
output instructions received from the information processing device to the user via acoustic output,
analyze a user emotional state based on voice or image information,
generate adaptive information based on the emotional state and output such information to the user,
analyze the user instruction content, environmental information, and emotional state using natural language processing to generate guidance and emotional support information,
and generate a prompt sentence specifying guidance or emotional support content to be generated based on the state of the user or system.

### (Supplementary 2)

The system according to supplementary 1,
wherein the processor is configured to
obtain response information provided by the user and update a model in the information generating device based on the response information.

### (Supplementary 3)

The system according to supplementary 1,
wherein the processor is configured to
transmit the acquired image information and route information to the information processing device, and, when the travel route needs to be modified, recalculate the new route in real time and output the corresponding information to the user.

What is claimed is:

1. A system comprising a processor that is configured to:
recognize instructions provided by a user via voice input;
capture images of the surrounding environment;
analyze acquired image data to identify obstacles and elevation changes;
calculate an optimal route to a user's destination;
control movement based on the calculated route;
transmit user instructions recognized by the voice recognition means as well as data analyzed by the image analysis means to a server;
receive instructions from the server; and
notify the user of instructions received from the server by voice.

2. The system according to claim 1, wherein the processor further receives feedback provided by the user and updates a model based on the feedback.

3. The system according to claim 1, wherein the processor transmits acquired image data and route information to the server and, if a change is required while en route, recalculates a new route in real time and receives instructions accordingly.
